(19) United States
(12) Patent Application Publication
(10) Pub. No.: US 2015/0028092 A1
(43) Pub. Date: Jan. 29, 2015

(54) Horse Training Stick

(71) Applicants: Rozanne E. Adams, Joseph, OR (US); Alan Dale, Joseph, OR (US)

(72) Inventors: Rozanne E. Adams, Joseph, OR (US); Alan Dale, Joseph, OR (US)

(21) Appl. No.: 14/340,779

(22) Filed: Jul. 25, 2014

Related U.S. Application Data
(60) Provisional application No. 61/858,486, filed on Jul. 25, 2013.

(51) Int. Cl. B68B 11/00

(52) U.S. Cl. CPC B68B 11/00
USPC 231/6

(57) ABSTRACT

A horse training stick that consists of an elongated body, a cord, a crook handle, a keeper, and an end cap. The elongated body and the cord allow the trainer to contact the horse from a distance by holding the crook handle. The end cap is attached on the opposite end of the elongated body. The cord is connected to the end cap. The keeper allows the cord to be stored when not in use. The keeper is mounted onto the elongated body and the position of the keeper can be changed according to user preference.

The current application claims a priority to the U.S. Provisional Patent application Ser. No. 61/858,486 filed on Jul. 25, 2013.

### FIELD OF THE INVENTION

The present invention relates generally to horse training equipment. More specifically, the present invention is an apparatus that can be used to control and guide a horse.

### BACKGROUND OF THE INVENTION

Traditionally, horses were trained for warfare, farm work, sport, and transport. With time, horses have been used for a variety of recreational and sporting events. Additionally, horses are also trained for movie stunt work, crowd control activities, and circus entertainment. Since horses are prey animals that have an inborn fight or flight instinct, a considerable amount of training is required to train horses regardless of the activity they are being used for.

The main intension of training a horse is to teach them to perform a series of behaviors when instructed by a human. The training methods can differ depending on the activity the horse is intended to be used for. More specifically, a horse that is intended to be used for racing will be trained different from a horse that is being trained for crowd control. However, a majority of the devices used in training are similar regardless of the training method. Spiral crops, side reins, hackamores, and horse training whips are some of the widely used equipment in horse training.

Horse training sticks are one of the most preferred equipment in horse training. The functionality of the horse training stick is such that, it acts as an extension of the trainer's hand. More specifically, it is used to avoid unfavorable situations when initiating contact with a new horse. Avoiding direct contact with a new horse is especially important since some horses' fear of touch to certain parts of the body. The cord section of the training stick is especially beneficial when making contact with the legs and feet of a young colt.

In traditional whips, the whip portion hangs freely from the rest of the apparatus. When riding a horse, a number of equipment is mounted onto the horse. In such instances, there is a high probability for the whip to be entangled within the mounted equipment. This can be dangerous and also stressful to a trainer. Therefore, the need for storing the whip when not in use is clearly evident.

Currently, individuals of a wide age range are involved in horse training. Especially young trainers may require assistance in handling equipment involved in horse training. However, none of the available training equipment has the ability to alternate as a pulling or guiding apparatus.

The objective of the present invention is to address the aforementioned issues. In particular, the present invention is a horse training stick with a cord. Furthermore, effective design of the present invention allows the cord to be secured when not in use. As a result, the user can utilize the horse training stick by itself.

### BRIEF DESCRIPTION OF THE DRAWINGS

FIG. 1 is a perspective view of the present invention, wherein the cord is in a storable configuration.

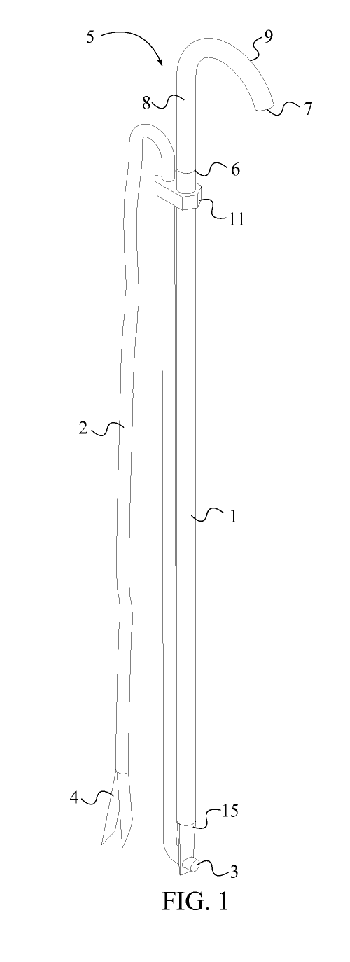

FIG. 2 is a perspective view of the present invention without the cord.

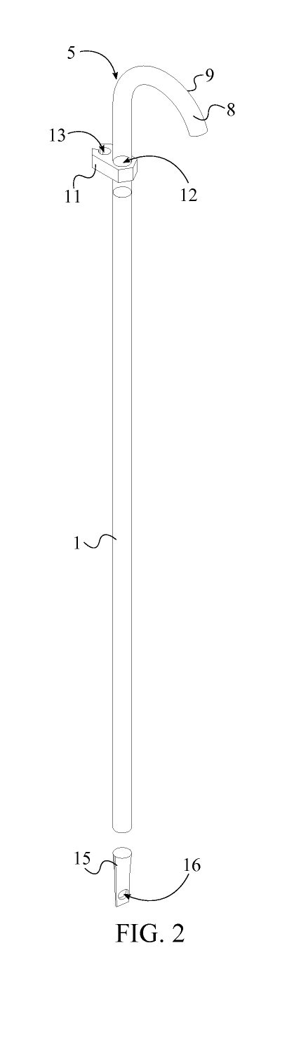

FIG. 3 is a perspective view of the elongated body.

FIG. 4 is a perspective view of the end cap.

FIG. 5 is a perspective view of the crook handle.

FIG. 6 is a perspective view of the keeper.

### DETAIL DESCRIPTIONS OF THE INVENTION

All illustrations of the drawings are for the purpose of describing selected versions of the present invention and are not intended to limit the scope of the present invention.

The present invention is an improved horse training stick that can be used when training a new horse. The horse training stick comprises an elongated body 1, a cord 2, a crook handle 5, and a keeper 10. The elongated body 1 helps a trainer to reach the new horse from a safe distance. The cord 2 is used to touch the legs and feet of the horse and desensitize the horse to the horse training stick. The crook handle 5 is used to control the elongated body 1 from a distance. Additionally, the crook handle 5 can also be used to grab or pull items a trainer comes across when training and other related activities. The keeper 10 is used to hold the cord 2, when the cord 2 is not used in training.

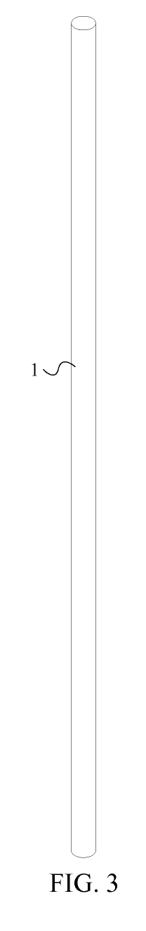

In the preferred embodiment of the present invention, the elongated body 1 is cylindrical in shape as illustrated in FIG. 3. The crook handle 5 and the keeper 10 are both connected to the elongated body 1 such that the entire assembly can be controlled simultaneously. In the preferred embodiment of the present invention, the elongated body 1 can be made of, but is not limited to, fiber glass or aluminum. Being lightweight is especially important since the present invention will be used in a variety of movements during the training process.

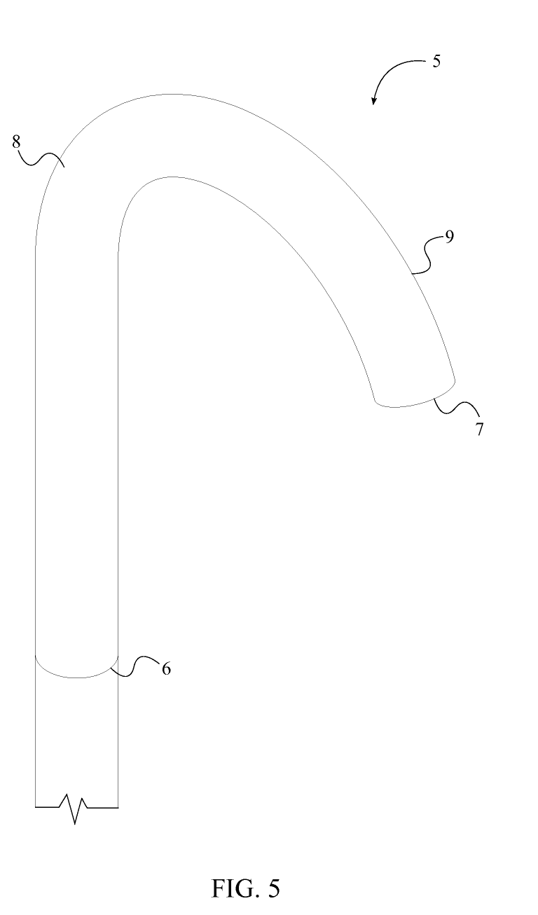

The crook handle 5 is illustrated in FIG. 5. The crook handle 5 comprises a proximal end 6 and a distal end 7, a J-shaped body 8, and a rubber outer covering 9. The crook handle 5 is adjacently connected to the elongated body 1. More specifically, the crook handle 5 is connected to the elongated body 1 at the proximal end 6 such that a trainer can control the elongated body 1 by holding the crook handle 5 at the distal end 7. Due to the J-shaped body 8, the crook handle 5 curves from the proximal end 6 to the distal end 7. The J-shaped body 8 is enclosed by the rubber outer covering 9 such that a trainer has a comfortable grasp of the horse training stick. Even though, a rubber outer covering 9 has been utilized in the preferred embodiment of the present invention, any other coarse yet comfortable material can also be utilized. Although the crook handle 5 is discussed separately from the elongated body 1, the crook handle 5 is not an independent component.

When training a horse, the cord 2 is used to desensitize a horse. More specifically, the cord 2 is used to familiarize the new horse with the trainer and the horse training stick. The cord 2 is adjacently connected to the elongated body 1 and positioned opposite to the crook handle 5. As a result, the trainer can control the cord 2 on the horse's body with the crook handle 5. In the preferred embodiment of the present invention, a braided cord 2 has been utilized for the cord 2. The cord 2 comprises a closed end 3 and a popper 4. In the preferred embodiment of the present invention, the popper 4 is made of leather such that the horse can be touched gently. The closed end 3 and the popper 4 are positioned opposite to each other along the cord 2. Therefore, the closed end 3 is connected to the elongated body 1 and the popper 4 is in contact with the horse during the training process. The effective design of the present invention allows the cord 2 to be stored within the keeper 10 when not in use.

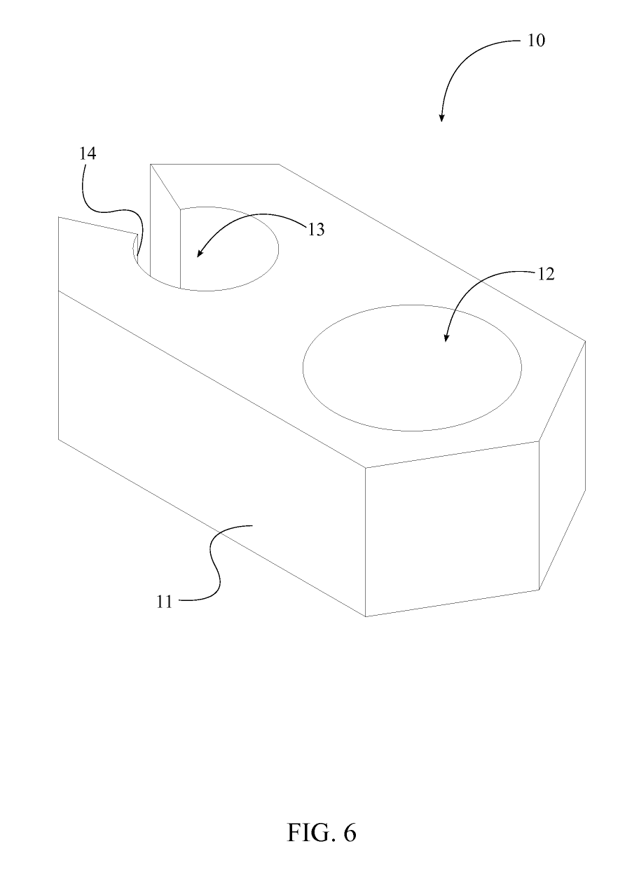

The keeper 10 is illustrated in FIG. 6. As seen in FIG. 6, the keeper 10 comprises a main body 11, a guide hole 13, a body receiving hole 12, and a tapered notch 14. The body receiving hole 12 traverses through the main body 11 creating a circular opening sufficient to receive the elongated body 1. The elongated body 1 traverses through the body receiving hole 12 such that the keeper 10 is slidably engaged with the elongated body 1. As a result, the position of the keeper 10 along the length of the elongated body 1 can be changed according to user preference. The guide hole 13 is utilized to store the cord 2 when the cord 2 is not used. As seen in FIG. 6, the guide hole 13 also traverses through the main body 11. More specifically, the guide hole 13 is positioned in parallel to the body receiving hole 12. In the storable configuration of the cord 2, the cord 2 is removably positioned within the guide hole 13. The tapered notch 14 is used to secure the cord 2 within the guide hole 13. In order to do so, the tapered notch 14 traverses into the guide hole 13 through the main body 11 and is positioned perpendicular to the guide hole 13. When the cord 2 is positioned within the guide hole 13, the cord 2 is pressed into the guide hole 13 by the tapered notch 14. In order to conveniently manipulate the cord 2 in and out of the keeper 10, the main body 11 is made of a flexible material. More specifically, the flexible material allows the cord 2 to be secured within the guide hole 13 and also be removed from the keeper 10 without losing its original shape.

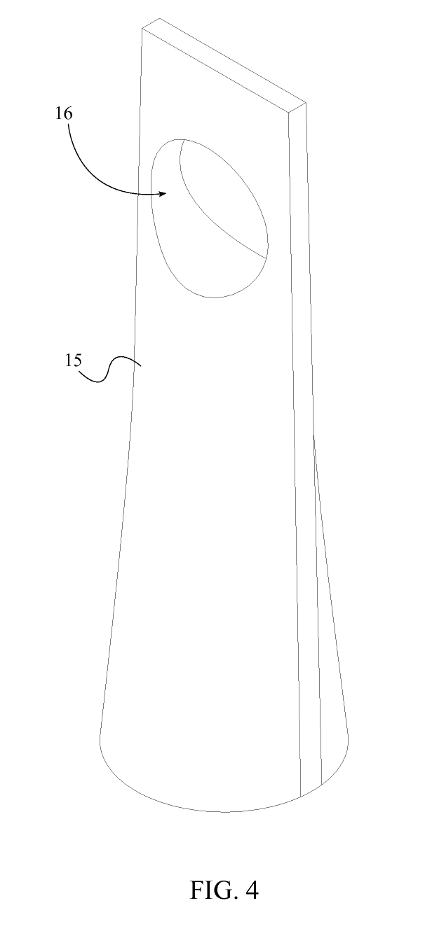

In the preferred embodiment of the present invention, the cord 2 is mounted to the elongated body 1 through an end cap 15. The end cap 15 is illustrated in FIG. 4. In the preferred embodiment of the present invention, the end cap 15 is made of rubber or other comparable material. A comfortable material is required for the end cap 15, such that the end cap 15 provides no inconvenience to the horse during training. The end cap 15 comprises a cord receiving hole 16 that traverses through the end cap 15. The cord 2 is mounted into the cord receiving hole 16 such that a firm connection is established between the elongated body 1 and the cord 2. More specifically, the closed end 3 is positioned within the cord 2 receiving hole.

In utilizing the present invention, the consequent process flow is followed. If the trainer intends on using the elongated body 1 as well as the cord 2, the cord 2 is removed from the guide hole 13. During training, the elongated body 1 and the cord 2 are both controlled by holding the crook handle 5. If a trainer intends on using only the elongated body 1, the cord 2 is stored within the guide hole 13. The ability to store the cord 2 eliminates the need to hold both the cord 2 and the elongated body 1 during training. When storing, the cord 2 can also be wrapped around the elongated body 1 initially and then stored in the guide hole 13. The tapered notch 14 ensures that the cord 2 does not come loose from the guide hole 13 in the training process. Additionally, the trainer can also use the J-shaped body 8 of the crook handle 5 in order to grab objects that might be utilized during training. In doing so, the user of the horse training stick can use the elongated body 1 to grasp the present invention.

Although the invention has been explained in relation to its preferred embodiment, it is to be understood that many other possible modifications and variations can be made without departing from the spirit and scope of the invention as hereinafter claimed.

What is claimed is:

1. A horse training stick comprises:
an elongated body;
a cord;
a crook handle;
a keeper;
the crook handle comprises a proximal end and a distal end;
the keeper comprises a guide hole, a body receiving hole, and a tapered notch;
the elongated body traversing through the body receiving hole;
the keeper being slidably engaged onto the elongated body;
the crook handle being adjacently connected to the elongated body; and
the cord being adjacently connected to the elongated body and positioned opposite the crook handle.

2. The horse training stick as claimed in claim 1, wherein the crook handle is connected to the elongated body at the proximal end.

3. The horse training stick as claimed in claim 1 comprises:
an end cap; and
the cord being mounted to the elongated body through the end cap.

4. The horse training stick as claimed in claim 2 comprises:
the end cap comprises a cord receiving hole;
the cord receiving hole traversing through the end cap; and
the cord being mounted into the cord receiving hole.

5. The horse training stick as claimed in claim 1 comprises:
the cord comprises a closed end and a popper;
the closed end and the popper being positioned opposite to each other along the cord; and
the closed end being positioned within the cord receiving hole.

6. The horse training stick as claimed in claim 1 comprises:
the keeper further comprises a main body;
the body receiving hole traversing through the main body;
the guide hole traversing through the main body;
the guide hole being positioned parallel to the body receiving hole;
the tapered notch traversing into the guide hole through the main body; and
the tapered notch being positioned perpendicular to the guide hole.

7. The horse training stick as claimed in claim 6, wherein the main body is made of a flexible material.

8. The horse training stick as claimed in claim 1 comprises:
wherein the cord is in a storable configuration;
the cord being removably positioned within the guide hole; and
the cord being pressed into the guide hole by the tapered notch.

9. The horse training stick as claimed in claim 1, wherein the cord is a braided cord.

10. The horse training stick as claimed in claim 1 comprises:
the crook handle further comprises a structural J-shaped body and a rubber outer covering; and
the structural J-shaped body being enclosed by the rubber outer covering.

11. A horse training stick comprises:
an elongated body;
a cord;
a crook handle;
a keeper;
an end cap;
the crook handle comprises a proximal end and a distal end;
the keeper comprises a guide hole, a body receiving hole, and a tapered notch;
the elongated body traversing through the body receiving hole;
the keeper being slidably engaged onto the elongated body;
the crook handle being adjacently connected to the elongated body;
the cord being adjacently connected to the elongated body and positioned opposite the crook handle;
the crook handle being connected to the elongated body at the proximal end; and
the cord being mounted to the elongated body through the end cap.

12. The horse training stick as claimed in claim 11 comprises:
the end cap comprises a cord receiving hole;
the cord receiving hole traversing through the end cap;
the cord being mounted into the cord receiving hole;
the cord comprises a closed end and a popper;
the closed end and the popper being positioned opposite to each other along the cord;
the closed end being positioned within the cord receiving hole;
the keeper further comprises a main body;
the body receiving hole traversing through the main body;
the guide hole traversing through the main body;
the guide hole being positioned parallel to the body receiving hole;
the tapered notch traversing into the guide hole through the main body;
the tapered notch being positioned perpendicular to the guide hole; and
the main body being made of a flexible material.

13. The horse training stick as claimed in claim 11 comprises:
wherein the cord is in a storable configuration;
the cord being removably positioned within the guide hole;
the cord being pressed into the guide hole by the tapered notch;
the cord being a braided cord;
the crook handle further comprises a structural J-shaped body and a rubber outer covering; and
the structural J-shaped body being enclosed by the rubber outer covering.

14. A horse training stick comprises:
an elongated body;
a cord;
a crook handle;
a keeper;
an end cap;
the crook handle comprises a proximal end and a distal end;
the keeper comprises a guide hole, a body receiving hole, and a tapered notch;
the elongated body traversing through the body receiving hole;
the keeper being slidably engaged onto the elongated body;
the crook handle being adjacently connected to the elongated body;
the cord being adjacently connected to the elongated body and positioned opposite the crook handle;
the crook handle being connected to the elongated body at the proximal end;
the cord being mounted to the elongated body through the end cap;
the end cap comprises a cord receiving hole;
the cord receiving hole traversing through the end cap;
the cord being mounted into the cord receiving hole;
the cord comprises a closed end and a popper;
the closed end and the popper being positioned opposite to each other along the cord; and
the closed end being positioned within the cord receiving hole.

15. The horse training stick as claimed in claim 14 comprises:
the keeper further comprises a main body;
the body receiving hole traversing through the main body;
the guide hole traversing through the main body;
the guide hole being positioned parallel to the body receiving hole;
the tapered notch traversing into the guide hole through the main body;
the tapered notch being positioned perpendicular to the guide hole;
the main body being made of a flexible material;
wherein the cord is in a storable configuration;
the cord being removably positioned within the guide hole;
the cord being pressed into the guide hole by the tapered notch;
the cord being a braided cord;
the crook handle further comprises a structural J-shaped body and a rubber outer covering; and
the structural J-shaped body being enclosed by the rubber outer covering.
